(19) United States
(12) Patent Application Publication
(10) Pub. No.: US 2010/0311261 A1
(43) Pub. Date: Dec. 9, 2010

(54) Universal Plug Adapter

(76) Inventor: Kuang-Hao Lee, Guang Dong (CN)

Correspondence Address: INHOUSE CO. Law Firm, Daimler Chrysler Building, 7700 Irvine Center Drive, Suite 800, Irvine, CA, 92618, US

(21) Appl. No.: 12/779,558

(22) Filed: May 13, 2010

(30) Foreign Application Priority Data
Jun. 5, 2009 (CN) 200920132486.9

(51) Int. Cl. H01R 27/00

(52) U.S. Cl. 439/223

(57) ABSTRACT

A universal plug adapter, comprising: a main body, at least a set of plug pins, an orientation guide rod allowing sliding of pins and a slide block restricting the shift of pins; the plug pin comprises of at least two pins of different sizes, of which a single pin can be pushed every time; a sliding groove is set laterally onto the slide block; the groove is deep upwards and shallow downwards; the pin is provided with a bulge; when the pin is pushed, the bulge moves along the groove of the slide block groove; given the different depth of the groove, the bulge pushes the slide block to shift, such that the bulges on other pins cannot be aligned with the center of the groove, so other pins not yet pushed are restricted in original position.

### BACKGROUND OF INVENTION

1. Field of the Invention

The present invention relates generally to a plug adapter, and more particularly to an innovative one which is designed with multiple retractable pins that can be used individually.

2. Description of Related Art

Conventional plug adapters are generally provided with a permanent pin, which is only mated with a plug jack. Yet, there are a variety of plug jacks, such as: flat, round, square and oblique, making it difficult for the permanent pin to meet the requirements. Hence, the conventional plug adapters are restricted by simple functions, limited applications and inconveniency.

### SUMMARY OF THE INVENTION

The features and the advantages of the present invention will be more readily understood upon a thoughtful deliberation of the following preferred embodiment with reference to the accompanying drawings:

### Preferred Embodiment 1

As shown in the figure, the plug adapter comprises a main body 1 and plug pin 2, of which the main body 1 comprises of upper cover plate 3, lower cover plate 4 and slide block 5; 4 orientation guide rods 6 are arranged squarely onto the lower cover plate 4, and the plug pin 2 is inserted onto 4 orientation guide rods 6; the plug pin 2 comprises of different pins; the slide block 5 is located at the center of four pins 2; the slide block 5 can shift freely in horizontal direction, but shifts slightly in elevation direction under the limitation of upper/lower cover plates 3, 4; orientation guide rods 6 are used for positioning the pins 2 and guiding the direction; the upper and lower cover plates 3, 4 form a space, which is slightly bigger than the height of the slide block 5 to restrict the excessive vertical shift of the slide block 5; 4 grooves 51 are arranged onto 4 lateral surfaces of the slide block 5; an inner oblique surface 52 is separately set at the lower end of 4 lateral surfaces; groove oblique surface D and groove oblique surface E are set at lower end of the groove 51; the pin 2 is provided with bulge 21 mated with the groove 51; the external oblique surface 22 is at the position of the bulge 21; the bulge 21 is located within the groove 51, whilst the external oblique surface 22 and inner oblique surface 52 slide collaboratively, such that the pin 2 can be retracted on the slide block 5, and the groove 51 is deep upwards and shallow downwards.

Working Principle:

In normal conditions, four pins 2 are retracted into the main body 1, and the slide block 5 is located in a free location, enabling free movement without interlocking with any pin 2; the external oblique surface 22 and bulge 21 of the pin 2 are fully positioned below the inner oblique surface 52 of slide block 5, groove oblique surface D and groove oblique surface E (see FIG. 7).

In working conditions, a pin 2 is pushed upwards along the orientation guide rod 6, and the bulge 21 of the pin 2 moves along the groove 51 of the slide block 5; given the different depth of the groove 51, the slide block 5 is pushed to shift, such that the bulges 21 on other pins 2 cannot be aligned with the center of the groove 51, so other pins 2 not yet pushed are restricted in original position, only a single pin is working (see FIG. 8).

The slide block 5 is of square, round, triangular and polygonal shapes.

### BRIEF DESCRIPTION OF THE DRAWINGS

FIG. 1: a structural view of the present invention;

FIG. 2: an internal structural view of FIG. 1;

FIG. 3: an exploded view of FIG. 2;

FIG. 4: a top view of FIG. 2;

FIG. 5: a structural view of retractable pin of FIG. 2;

FIG. 6: a structural view of slide block of FIG. 2; and

FIG. 7: a sectional view of FIG. 2, showing the relative position of the slide block and retractable pin.

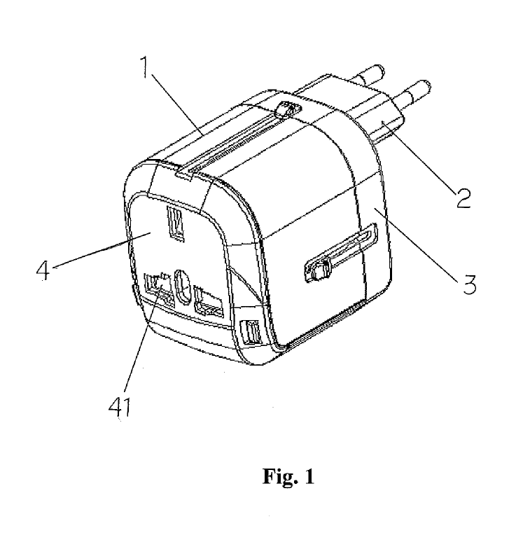

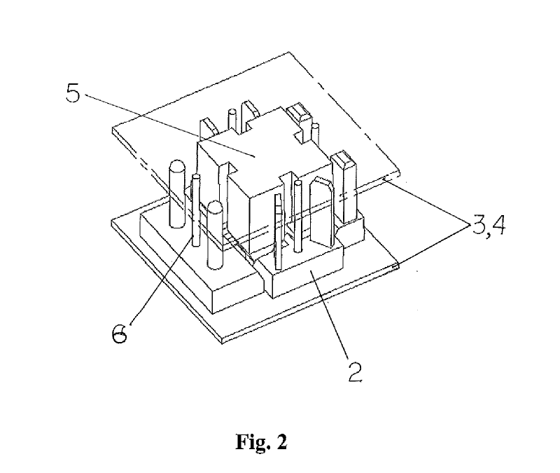

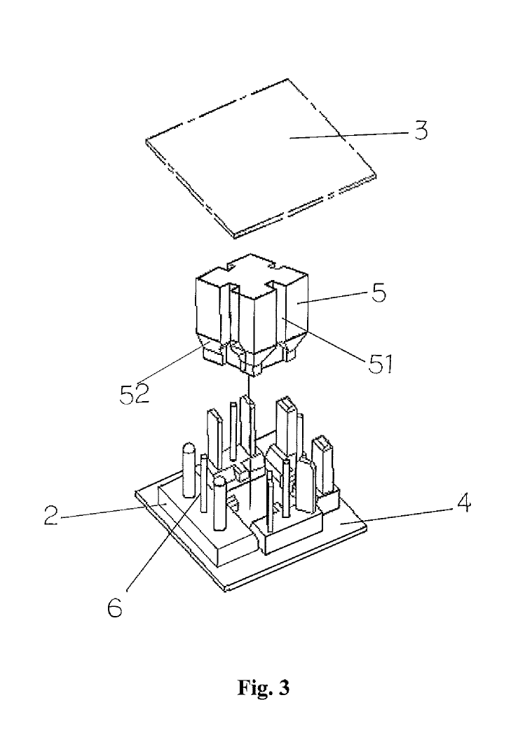

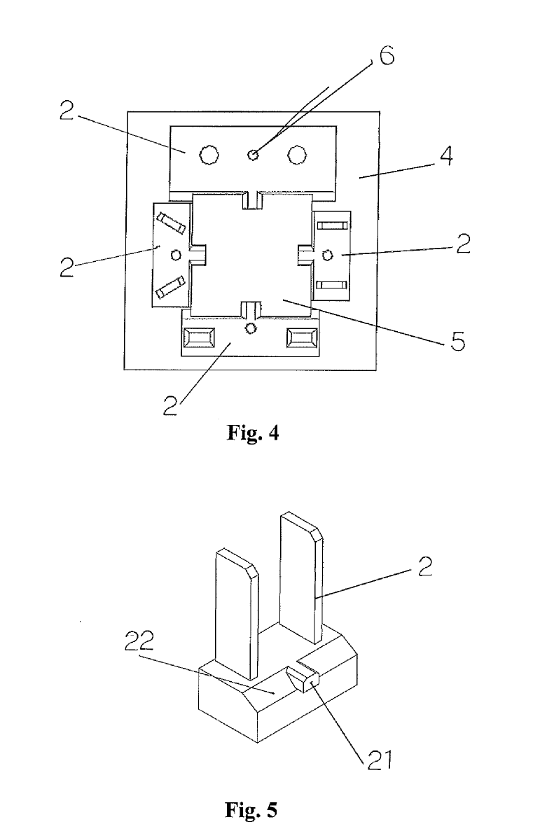

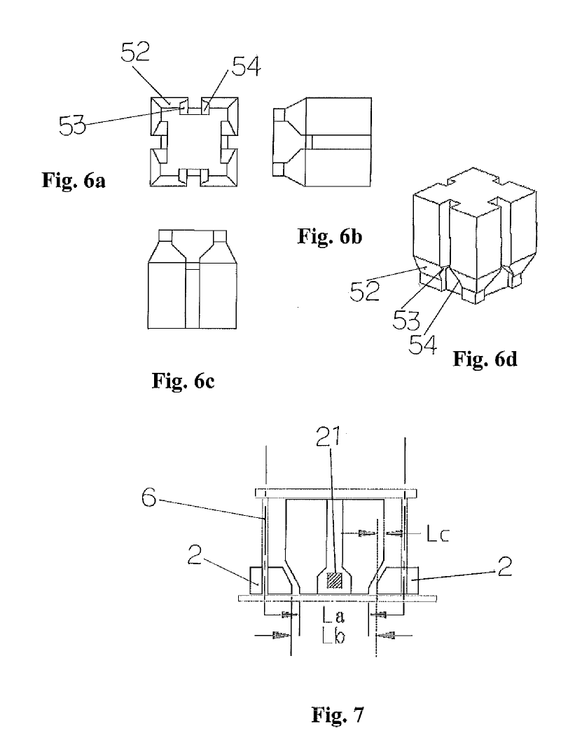

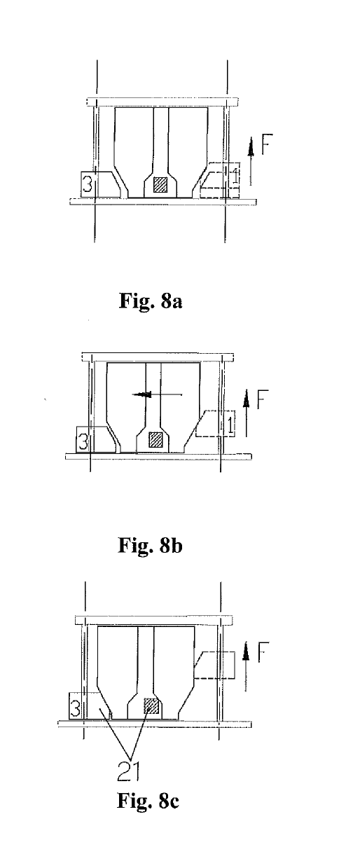

### CONTENT OF INVENTION

The primary objective of the invention is to provide a universal plug adapter, wherein the slide block and multiple retractable pins are mated to overcome the shortcomings of existing plug adapter, making it possible to adapt to different plug jacks.

The technical package of the utility model is: the adapter comprises a main body, at least a set of plug pins, an orientation guide rod allowing sliding of pins and a slide block restricting the shift of pins; the plug pin comprises of at least two pins of different sizes, of which a single pin can be pushed every time; a sliding groove is set laterally onto the slide block; the groove is deep upwards and shallow downwards; the pin is provided with a bulge; when the pin is pushed, the bulge moves along the groove of the slide block groove; given the different depth of the groove, the bulge pushes the slide block to shift, such that the bulges on other pins cannot be aligned with the center of the groove, so other pins not yet pushed are restricted in original position; a slide block is arranged at the center of the pin configuration, whilst a groove of different depth is arranged at three or four sides of the slide block.

The technical package also comprises:

said slide block is hollow, wherein fuse or indicator can be located.

said slide block is round, around which at least three grooves are arranged; the same groove is of different depth.

said slide block is round and hollow, wherein fuse or indicator can be located.

said main body is provided with a plug adapter.

said main body is provided with AC/DC plug module, whilst an output of USB is arranged externally.

The inner oblique surface is placed at lower end at one side of said slide block, and the external oblique surface is located at the plug pin's bulge; said external oblique surface is mated with said inner oblique surface.

Said lower cover plate is provided with orientation guide rod allowing the sliding of plug pin.

Advantages of the utility model: multiple retractable pins are arranged to realize diversified functions, operate easily and save the cost through the simple structure.

1. A universal plug adapter, comprising: a main body, at least a set of plug pins, an orientation guide rod allowing sliding of pins and a slide block restricting the shift of pins; the plug pin comprises of at least two pins of different sizes, of which a single pin can be pushed every time; a sliding groove is set laterally onto the slide block; the groove is deep upwards and shallow downwards; the pin is provided with a bulge; when the pin is pushed, the bulge moves along the groove of the slide block groove; given the different depth of the groove, the bulge pushes the slide block to shift, such that the bulges on other pins cannot be aligned with the center of the groove, so other pins not yet pushed are restricted in original position; a slide block is arranged at the center of the pin configuration, whilst a groove of different depth is arranged at three or four sides of the slide block.

2. The universal plug adapter as claimed in claim 1, wherein said slide block is hollow, wherein fuse or indicator can be located.

3. The universal plug adapter as claimed in claim 1, wherein said slide block is round, around which at least three grooves are arranged; the same groove is of different depth.

4. The universal plug adapter as claimed in claim 3, wherein said slide block is round and hollow, wherein fuse or indicator can be located.

5. The universal plug adapter as claimed in claim 1, wherein said main body is provided with a plug adapter.

6. The universal plug adapter as claimed in claim 1, wherein said main body is provided with AC/DC plug module, whilst an output of USB is arranged externally.
